(19) United States
(12) Patent Application Publication
(10) Pub. No.: US 2008/0139834 A1
(43) Pub. Date: Jun. 12, 2008

(54) Method of Making Phenyl-Containing Chlorosilanes with Aliphatic or Cycloparaffinic Hydrocarbon Solvents

(75) Inventors: Dana C. Bauer, Saginaw, MI (US); Curtis John Bedbury, Midland, MI (US); Binh Thanh Nguyen, Midland, MI (US)

Correspondence Address: DOW CORNING CORPORATION CO1232, 2200 W. SALZBURG ROAD, P.O. BOX 994, MIDLAND, MI, 48686-0994, US

(73) Assignee: DOW CORNING CORPORATION, Midland, MI (US)

(21) Appl. No.: 11/883,151

(22) PCT Filed: Jan. 25, 2006
(86) PCT No.: PCT/US06/02760

§ 371 Date: Jul. 26, 2007

Related U.S. Application Data
(60) Provisional application No. 60/648,753, filed on Feb. 1, 2005.

(51) Int. Cl. C07F 7/16

(52) U.S. Cl. 556/480

(57) ABSTRACT

Phenylmethyldichlorosilanes and diphenylmethylchlorosilanes are prepared by a Grignard process involving the step of contacting a phenyl Grignard reagent, an ether solvent, a trichlorosilane, and an aliphatic or cycloparaffinic hydrocarbon coupling solvent; in a mole ratio of the ether solvent to the phenyl Grignard reagent is 2 to 5, the mole ratio of the trichlorosilane to the phenyl Grignard reagent is 0.1 to 10, and the mole ratio of the aliphatic or cycloparaffinic hydrocarbon coupling solvent to the phenyl Grignard reagent is 3 to 7. Preferred reactants include phenylmagnesium chloride as the phenyl Grignard reagent; diethyl ether as solvent; n-heptane as the aliphatic hydrocarbon coupling solvent, or cyclohexane as the cycloparaffinic hydrocarbon coupling solvent; and methyltrichlorosilane.

### CROSS-REFERENCE TO RELATED APPLICATIONS

None

### STATEMENT REGARDING FEDERALLY SPONSORED RESEARCH

None

### BACKGROUND OF THE INVENTION

This invention is directed to a method of making certain phenyl-containing chlorosilanes in which an aliphatic or cycloparaffinic hydrocarbon coupling solvent is employed.

The National Emission Standard for Hazardous Air Pollutants (NESHAP), known as the Miscellaneous Organic NESHAP or the MON rule, is a regulation that was published on Nov. 10, 2003, by the US Environmental Protection Agency (EPA), 40 Code of Federal Regulations, Part 63, Subpart FFFF. Under the MON rule, chemical manufacturers and producers subject to the rule are required to be in compliance by Nov. 10, 2006. Many facilities are currently initiating MON compliance efforts, since affected operations may be required to make substantial capital investment in new air-pollution control technology, and make provisions to continually monitor emissions, and report their compliance status to state and federal authorities.

For example, to be considered a major source, an entire plant needs only to have the potential to emit 10 ton per year of a single Hazardous Air Pollutant (HAP), or 25 ton per year of all HAPs. Aromatic hydrocarbon compounds such as benzene, toluene, and xylenes are among listed HAPs. However, other hydrocarbon compounds such as aliphatic and cycloparaffinic hydrocarbons, i.e., heptane and cyclohexane, are not among listed HAPs, and hence are exempt. Therefore, it follows that if the process according to the invention is used, then in some cases, no extra major capital investment may be required for any facility using the instant technique.

In view of the above, and according to the method of the present invention, certain phenyl-containing chlorosilanes are prepared in which the aromatic hydrocarbon coupling solvent typically used in such processes, is replaced with an aliphatic or cycloparaffinic hydrocarbon coupling solvent. In particular, a straight or branched chain alkane CₙH₂ₙ₊₂ such as n-heptane, is used as a replacement coupling solvent, for the oft-used coupling solvent toluene, i.e., see for example U.S. Pat. No. 6,541,651 (Apr. 1, 2003), and copending U.S. Provisional Application Ser. No. 60/534,443, (Jan. 6, 2004). Cycloparaffinic hydrocarbons CₙH₂ₙ, such as cyclohexane, can also be used as the coupling solvent.

### BRIEF SUMMARY OF THE INVENTION

This invention relates to Grignard processes for preparing phenylmethyldichlorosilanes and diphenylmethylchlorosilanes. In the process, the reactants of the Grignard process comprise a phenyl Grignard reagent, an ether solvent, a trichlorosilane, and an aliphatic or cycloparaffinic hydrocarbon coupling solvent. The phenyl Grignard reagent is preferably phenylmagnesium chloride; the ether solvent is a dialkyl ether such as dimethyl ether, diethyl ether (Et₂O), ethyl methyl ether, n-butyl methyl ether, n-butyl ethyl ether, di-n-butyl ether, di-isobutyl ether, isobutyl methyl ether, and isobutyl ethyl ether; the aliphatic or cycloparaffinic hydrocarbon solvent is preferably n-heptane or cyclohexane, respectively; and the trichlorosilane is preferably methyltrichlorosilane, phenyltrichlorosilane, or vinyltrichlorosilane.

The mole ratio of the ether solvent to the phenyl Grignard reagent is 2 to 5, the mole ratio of the trichlorosilane to the phenyl Grignard reagent is 0.1 to 10, and the mole ratio of the aliphatic or cycloparaffinic hydrocarbon coupling solvent to the phenyl Grignard reagent is 3 to 7.

It was discovered that by replacing toluene with n-heptane, an aliphatic or cycloparaffinic hydrocarbon solvent, as the coupling solvent, that the diethyl ether/n-heptane cosolvent system allowed magnesium chloride to precipitate very efficiently. The use of this diethyl ether/n-heptane system also provided very low viscosity slurries from which the magnesium chloride could be readily separated because a very flowable Grignard reaction mixture was obtained. The commonly encountered second very fine magnesium chloride layer disappeared as well. Gas chromatography (GC) analysis of the reaction mixture showed that the diethyl ether/n-heptane system functioned as well as diethyl ether/toluene systems, if not even better, in terms of product formation, and because the diethyl ether/n-heptane system generated less by-products. These and other features of the invention will become apparent from a consideration of the detailed description.

### BRIEF DESCRIPTION OF THE DRAWING

None

### DETAILED DESCRIPTION OF THE INVENTION

As used herein, the term normal coupling refers to reactions of a phenyl Grignard reagent chloride with a trichlorosilane; the term co-coupling refers to reactions of the phenyl Grignard reagent the trichlorosilane and a phenylchlorosilane; and the term direct coupling refers to reactions of the phenyl Grignard reagent with the phenylchlorosilane. The abbreviations Et, Me, and Ph, refer to ethyl, methyl, and phenyl, respectively

The Grignard process employed according to this invention is illustrated below in chemical reactions (I) and (II). This represents normal coupling. n-Heptane is also one of the products of chemical reaction (II), but n-heptane is not shown in the reaction.

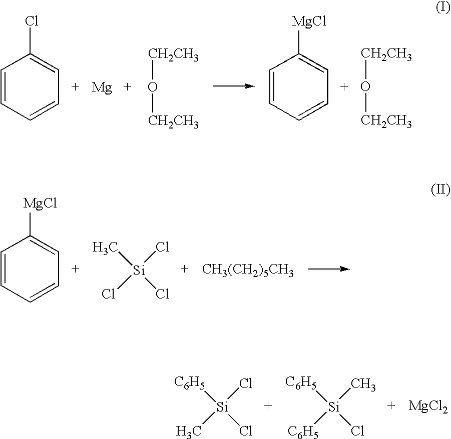

In chemical reaction (I), phenyl chloride/chlorobenzene (PhCl) is combined with magnesium metal (Mg) in the presence of the solvent diethyl ether (CH₃CH₂—O—CH₂CH₃), to form phenylmagnesium chloride (PhMgCl) in diethyl ether. Phenylmagnesium chloride in diethyl ether is then used in chemical reaction (II) where it is combined with methyltrichlorosilane (MeSiCl₃) and the preferred coupling solvent n-heptane. The products of chemical reaction (II) are phenylmethyldichlorosilane (PhMeSiCl₂), diphenylmethylchlorosilane (Ph₂MeSiCl), magnesium chloride, and n-heptane.

Chlorosilanes useful according to the invention have the general formula RₐSiX₄₋ₐ wherein each R can represent a phenyl group, methyl group, vinyl group, or hydrogen; X represents chlorine or bromine; and a has a value of 0, 1, or 2. Some suitable and representative chlorosilanes which can be used include silicon tetrachloride, methyltrichlorosilane, dimethyldichlorosilane, phenylmethyldichlorosilane, phenyltrichlorosilane, diphenyldichlorosilane, vinyltrichlorosilane, hydridotrichlorosilane, divinyldichlorosilane, methylvinyldichlorosilane, phenylvinyldichlorosilane, hydridomethyldichlorosilane, hydridophenyldichlorosilane, hydridovinyldichlorosilane and dihydridodichlorosilane.

Magnesium metal useful in this invention can be any of the forms of the metal currently being used in Grignard-type reactions. For example, the metal can be in the form of a powder, flake, granule, chip, lump, or shaving. Contact of the magnesium metal with the phenyl halide can be undertaken in standard type reactors suitable for running Grignard type reactions. Thus, the reactor can be a batch, semi-batch, or continuous type reactor. A preferred reactor is a continuous reactor. The environment in which the present method is carried out should be inert for best results. Therefore, under preferred conditions of the method, the reactor is purged and blanketed with an inert gas such as nitrogen or argon.

Phenyl halides useful in this invention are those of the formula RX wherein R represents phenyl and X is a chlorine or bromine atom. The preferred phenyl halide for this invention is phenyl chloride (chlorobenzene). Solvents for synthesizing the Grignard reagent include dialkyl ethers such as dimethyl ether, diethyl ether, ethylmethyl ether, n-butylmethyl ether, n-butylethyl ether, di-n-butyl ether, di-isobutyl ether, isobutylmethyl ether, and isobutylethyl ether. The most preferred ether solvent is diethyl ether.

The coupling solvent in the coupling reaction of the phenyl Grignard reagent PhMgCl with PhMeSiCl₂ or MeSiCl₃ according to the processes of this invention, is an aliphatic or cycloparaffinic hydrocarbon. While n-heptane is the preferred coupling solvent, other unbranched alkanes can also be used such as butane, pentane, hexane, octane, nonane, and decane, for example. As previously noted, cycloparaffins can also be used as the coupling solvent, such as cyclobutane, cyclopentane, cyclohexane, cycloheptane, and derivatives such as methylcyclopentane, and methylcyclohexane. Phenyl Grignard reagents such as PhMgCl can either be synthesized or purchased commercially, as desired.

### EXAMPLES

The following examples are set forth in order to illustrate the invention in more detail.

### Comparison Example 1

### Baseline Normal Coupling with Toluene

In a 1-L stirred flask, 143.8 gram of high performance liquid chromatography (HPLC) grade toluene and 234.6 gram MeSiCl₃ were mixed. Over a 21 minute period, 222 gram of PhMgCl in Et₂O was added. The PhMgCl had a density of 0.91 gram/ml and an estimated concentration of 2.15 ml/L as determined by an MeOH quench method. The reaction mixture reached 61° C. at the end of the 21 minutes feeding period. The total recovered product weighed 572.6 gram. The liquid and solid mixture was placed in a 32 ounce bottle and the solids were allowed to settle out. The total height of the liquid and solids was 9.7 centimeter, while the height of the solids alone was 3.6 centimeter. The density of the liquid was 0.975 gram/ml. The composition of the liquid was determined by gas chromatography (GC) and is shown in Table 1.

TABLE 1

| Component | Weight Percent |
|---|---|
| Diethyl Ether | 14.558 |
| MeSiCl₃ | 33.248 |
| Benzene | 0.623 |
| MeSi(OEt)Cl₂/MeEtSiCl₂ | 0.146 |
| Toluene | 27.956 |
| PhCl | 5.916 |
| PhMeHSiCl | 0.52 |
| PhMeSiCl₂ | 15.814 |
| Biphenyl | 0.541 |
| Ph₂MeSiH | 0.517 |
| Ph₂MeSiCl | 0.162 |

### Comparison Example 2

### Baseline Normal Coupling with Toluene

In a 1-L stirred flask, 127.6 gram of HPLC toluene and 206.6 gram MeSiCl₃ were mixed. Over a 19 minute period, 215 gram of PhMgCl in Et₂O was added. The PhMgCl had a density of 0.91 gram/ml and a concentration of 1.96 mol/L as determined by the MeOH quench method. The reaction mixture reached 62° C. near the end of the feeding period. The total recovered product weighed 523.4 gram. The liquid and solid mixture was placed in a 32 ounce bottle and the solids were allowed to settle out. The total height of the liquid and solids was 8.8 centimeter, while the height of the solids alone was 3.3 centimeter. The density of the liquid was 0.983 gram/ml. The composition of the liquid as determined by GC is shown in Table 2.

TABLE 2

| Component | Weight Percent |
|---|---|
| Diethyl Ether | 14.866 |
| MeSiCl₃ | 31.981 |
| Benzene | 0.663 |
| MeSi(OEt)Cl₂/MeEtSiCl₂ | 0.139 |
| Toluene | 27.775 |
| PhCl | 6.164 |
| PhMeHSiCl | 0.504 |
| PhMeSiCl₂ | 16.502 |
| Biphenyl | 0.568 |
| Ph₂MeSiH | 0.655 |
| Ph₂MeSiCl | 0.183 |

### Example 3

### Normal Coupling with n-Heptane

In a 1-L stirred flask, 148.1 gram of HPLC n-heptane and 221.9 gram MeSiCl₃ were mixed. Over a 22 minute period, 230 gram of PhMgCl in Et₂O was added. The PhMgCl had a density of 0.91 gram/ml and a concentration of 1.96 mol/L as determined by the MeOH quench method. The reaction mixture reached 59° C. at the end of the feeding period. The total recovered product weighed 580.0 gram. The liquid and solid mixture was placed in a 32 ounce bottle and the solids were allowed to settle out. The total height of the liquid and solids was 10.6 centimeter, while the height of the solids alone was 4.1 centimeter. The density of the liquid was 0.874 gram/ml. The composition of the liquid as determined by GC is shown in Table 3.

TABLE 3

| Component | Weight Percent |
|---|---|
| Diethyl Ether | 14.603 |
| MeSiCl₃ | 30.752 |
| Benzene | 0.631 |
| n-Heptane | 29.892 |
| Heptane Isomer | 0.187 |
| Toluene | 0.112 |
| PhCl | 5.942 |
| PhMeHSiCl | 0.54 |
| PhMeSiCl₂ | 16.146 |
| Biphenyl | 0.525 |
| Ph₂MeSiH | 0.506 |
| Ph₂MeSiCl | 0.163 |

### Example 4

### Normal Coupling with n-Heptane

In a 1-L stirred flask, 148.8 gram of HPLC n-heptane and 222.4 gram MeSiCl₃ were mixed. Over a 21 minute period, 230 gram of PhMgCl in Et₂O was added. The PhMgCl had a density of 0.91 gram/ml and a concentration of 1.96 mol/L as determined by the MeOH quench method. The reaction mixture reached 58° C. at the end of the feeding period. The total recovered product weighed 579.7 gram. The liquid and solid mixture was placed in a 32 ounce bottle and the solids were allowed to settle out. The total height of the liquid and solids was 10.6 centimeter, while the height of the solids alone was 3.9 centimeter. The density of the liquid was 0.879 gram/ml. The composition of the liquid as determined by GC is shown in Table 4.

TABLE 4

| Component | Weight Percent |
|---|---|
| Diethyl Ether | 14.637 |
| MeSiCl₃ | 30.713 |
| Benzene | 0.63 |
| Heptane | 30.232 |
| Heptane Isomer | 0.136 |
| Toluene | 0.111 |
| PhCl | 5.945 |
| PhMeHSiCl | 0.546 |
| PhMeSiCl₂ | 15.855 |
| Biphenyl | 0.521 |
| Ph₂MeSiH | 0.504 |
| Ph₂MeSiCl | 0.168 |

Other variations may be made in compounds, compositions, and methods described herein without departing from the essential features of the invention. The embodiments of the invention specifically illustrated herein are exemplary only and not intended as limitations on their scope except as defined in the appended claims.

1. A process for preparing phenylmethyldichlorosilanes and diphenylmethylchlorosilanes by the Grignard process comprising contacting a phenyl Grignard reagent, an ether solvent, a trichlorosilane, and an aliphatic or cycloparaffinic hydrocarbon coupling solvent; wherein the mole ratio of the ether solvent to the phenyl Grignard reagent is 2 to 5, the mole ratio of the trichlorosilane to the phenyl Grignard reagent is 0.1 to 10, and the mole ratio of the aliphatic or cycloparaffinic hydrocarbon coupling solvent to the phenyl Grignard reagent is 3 to 7.

2. The process according to claim 1 wherein the phenyl Grignard reagent is phenylmagnesium chloride.

3. The process according to claim 1 wherein the ether solvent is a dialkyl ether selected from the group consisting of dimethyl ether, diethyl ether, ethyl methyl ether, n-butyl methyl ether, n-butyl ethyl ether, di-n-butyl ether, di-isobutyl ether, isobutyl methyl ether, and isobutyl ethyl ether.

4. The process according to claim 1 wherein the trichlorosilane is selected from the group consisting of methyltrichlorosilane, phenyltrichlorosilane, and vinyltrichlorosilane.

5. The process according to claim 1 wherein the aliphatic hydrocarbon coupling solvent is selected from the group consisting of butane, pentane, hexane, n-heptane, octane, nonane and decane.

6. The process according to claim 1 wherein the aliphatic hydrocarbon coupling solvent is n-heptane.

7. The process according to claim 1 wherein the cycloparaffinic hydrocarbon coupling solvent is selected from the group consisting of cyclobutane, cyclopentane, cyclohexane, cycloheptane, methylcyclopentane, and methylcyclohexane.

8. The process according to claim 1 wherein the cycloparaffinic hydrocarbon coupling solvent is cyclohexane.

9. The process according to claim 2 wherein the ether solvent is a dialkyl ether selected from the group consisting of dimethyl ether, diethyl ether, ethyl methyl ether, n-butyl methyl ether, n-butyl ethyl ether, di-n-butyl ether, di-isobutyl ether, isobutyl methyl ether, and isobutyl ethyl ether.

10. The process according to claim 3 wherein the aliphatic hydrocarbon coupling solvent is selected from the group consisting of butane, pentane, hexane, n-heptane, octane, nonane and decane.

11. The process according to claim 9 wherein the aliphatic hydrocarbon coupling solvent is selected from the group consisting of butane, pentane, hexane, n-heptane, octane, nonane and decane.

12. The process according to claim 3 wherein the cycloparaffinic hydrocarbon coupling solvent is selected from the group consisting of cyclobutane, cyclopentane, cyclohexane, cycloheptane, methylcyclopentane, and methylcyclohexane.

13. The process according to claim 9 wherein the cycloparaffinic hydrocarbon coupling solvent is selected from the group consisting of cyclobutane, cyclopentane, cyclohexane, cycloheptane, methylcyclopentane, and methylcyclohexane.
